(19) United States
(12) Patent Application Publication
(10) Pub. No.: US 2025/0053721 A1
(43) Pub. Date: Feb. 13, 2025

(54) METHOD TO DERIVE THE LOCATION AND SIZE OF OXIDE SPACING AREA

(71) Applicant: UNITED MICROELECTRONICS CORP., Hsin-Chu City (TW)

(72) Inventors: Zih-Wun Peng, Tainan City (TW); Chih-Yueh Li, Taipei City (TW); Ya-Ching Cheng, Hsinchu City (TW); Yu-Ying Hu, Tainan City (TW); Da-Ching Liao, Taichung City (TW); Po-Jen Hsiao, New Taipei City (TW)

(73) Assignee: UNITED MICROELECTRONICS CORP., Hsin-Chu City (TW)

(21) Appl. No.: 18/378,633

(22) Filed: Oct. 10, 2023

(30) Foreign Application Priority Data
Aug. 7, 2023 (TW) 112129537

(51) Int. Cl. G06F 30/398

(52) U.S. Cl. CPC G06F 30/398; G06F 2119/18

(57) ABSTRACT

A method to derive the location and size of oxide spacing area is provided in the present invention, including steps of dividing a tested region into a plurality of grid units, each grid unit consists of a plurality of sub-grid units, calculating a pattern density difference, a minimum row/column pattern density and a row/column pattern density difference of every grid unit based on layout data, and determining a grid unit as where an oxide spacing area locates at when its pattern density difference is greater than a first predetermined value, its minimum row/column pattern density is less than a second predetermined value and its row/column pattern density difference is greater than a third predetermined value.

### BACKGROUND OF THE INVENTION

### 1. Field of the Invention

The present invention relates generally to a method to derive the location and size of oxide spacing area, and more specifically, to a method to derive the location and size of oxide spacing area based on the pattern density difference in a grid region.

### 2. Description of the Prior Art

In chemical mechanical planarization (CMP) process, spacing area (ex. oxide spacing area) between pattern areas (ex. dense area of copper interconnect lines) is a high risk location that dishing defect may occur. The larger the width of the spacing area, for example greater than 0.5 μm, the lower the step height reduced in the grid, and defect will be more prone to occur. Therefore, how to find the locations of these high risk spacing areas and predict their step heights based on their size is a critical factor in semiconductor design and test. As far as testkey pattern is concerned, the location and size of spacing area therein may be precisely reached since regular patterns and split conditions can be designed in testkey to establish model. However, with regard to actual products, patterns of various products in GDS format is irregular and inconsistent, thus it can't be used to simulate the product even the model is established if data like the location and size of oxide spacing area can't be extracted from the product. Accordingly, those of skilled in the art is necessary to develop a method for reaching the location and size of spacing area, and this method should be able to be implemented both in the GDS files of testkey and product.

### SUMMARY OF THE INVENTION

In the light of the aforementioned demands, the present invention hereby provides a novel method to derive the location and size of oxide spacing area, with feature that numerical values like pattern density difference, minimum row/column pattern density, row/column pattern density difference and minimum and second minimum pattern densities of sub-grid unit in every grid unit are calculated based on layout data, so that the location and width of oxide spacing area may be obtained accordingly.

The purpose of present invention is to provide a method to derive the location and size of oxide spacing area, with steps including: dividing a tested region in a GDS file into a grid composed of a plurality of grid units with a specified dimension, wherein each grid unit consists of a plurality of sub-grid units with a specified dimension and arranged in a plurality of sub-grid columns and a plurality of sub-grid rows; extracting layout data in the tested region; calculating a pattern density difference of every grid unit based on the layout data, wherein the pattern density difference is equal to a pattern density of one of the sub-grid units with maximum pattern density in the grid unit minus a pattern density of one of the sub-grid units with minimum pattern density in the grid unit; calculating a minimum row/column pattern density based on the layout data, wherein the minimum row/column pattern density is a pattern density of one of the sub-grid columns and the sub-grid rows with minimum pattern density in the grid unit; calculating a row/column pattern density difference of every grid unit based on the layout data, wherein the row/column pattern density difference is equal to a pattern density of one of the sub-grid rows with minimum pattern density in the grid unit rows minus a pattern density of one of the sub-grid columns with minimum pattern density in the grid unit columns; and if the pattern density difference of the grid unit is greater than a first predetermined value, the minimum row/column pattern density of the grid unit is less than a second predetermined value, and the row/column pattern density difference is greater than a third predetermined value, the grid unit is determined as where an oxide spacing area locates at.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the method to derive the location and size of oxide spacing area in accordance with the embodiment of present invention;

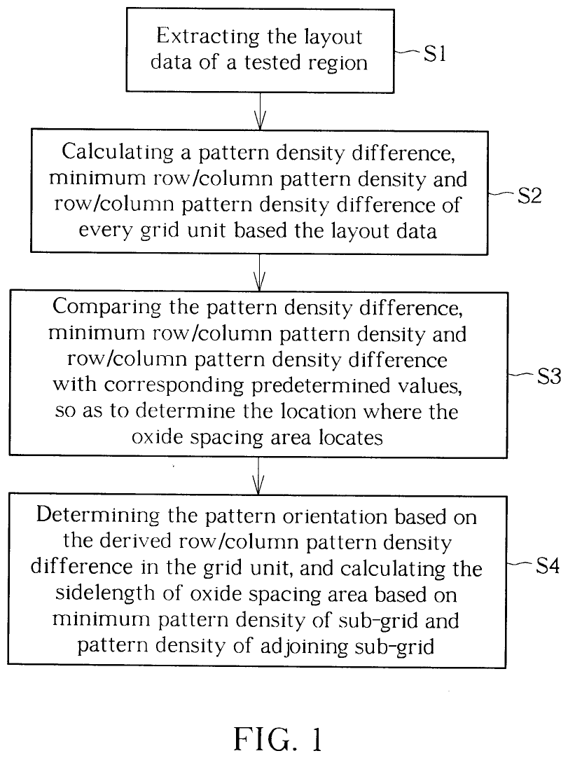

FIG. 2 is a schematic layout pattern with an oxide spacing area in accordance with the embodiment of present invention;

FIG. 3 is a chart with data like pattern density difference, minimum row/column pattern density and row/column pattern density difference of every grid unit reached by the method of present invention;

FIG. 4 is a schematic view of grid units having oxide spacing areas obtained by the method of present invention;

FIG. 5 is a schematic view of several types of oxide spacing area in accordance with the embodiment of present invention.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Preferably, one or more of such embodiments of the present invention are embodied in a computer implemented program or control system, ex. GDS format file or electronic design automation (EDA) tool. The computer for executing this kind of program or control system may be a general purpose computer architecture, wherein user may enter commands for executing the computer-implemented methods of the present invention through user interfaces like displayer, keyboard or mouse, or these methods may be executed automatically through automatic control system. The processor in the computer may access, calculate and process the computer readable code and data from the memory of computer. High capacity storage device like disk drive may provide program code or data relevant to the computer-implemented methods of the present invention and load them into the memory. Input/output device may provide connectivity to various equipment, ex. networks, modems, printers or process tools.

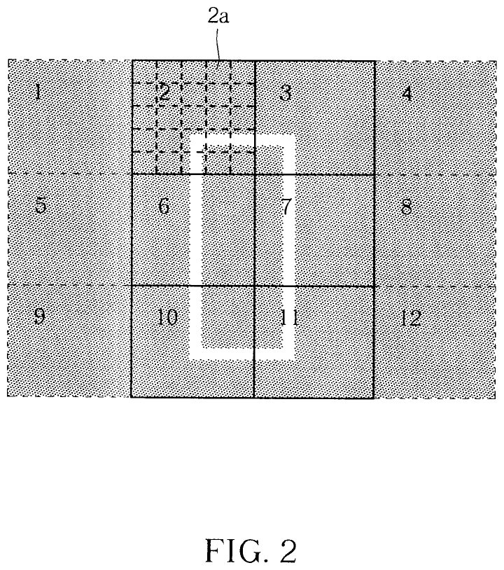

Reference will now be made hereinafter to describe the process flow of deriving the location and size of oxide spacing area in accordance with the preferred embodiment of present invention, wherein involved steps may be referred respective and collectively to FIG. 2 through FIG. 5 to provide further detailed and specific description, in order to provide a better understanding of the detailed features and approaches in the flow for readers.

Please refer to step S1. Extract a layout data in a region to be tested. The layout data in the present invention may be a file in GDS format, stored in a computer readable storage medium, ex. disk drive, and may be opened and operated through specific EDA tool. More specifically, in the embodiment of present invention as shown in FIG. 2, a tested region in a GDS file is divided into a grid composed of a plurality of grid units 1-12 with a specified dimension. The grid unit is preferably square, for example a square with a dimension of 10 μm*10 μm. It can be seen in FIG. 2 that the shaded region in the figure is pattern area, ex. dense area of copper interconnect lines, while the blank area between pattern areas is spacing area, ex. oxide spacing area. The purpose of present invention is to derive the location and size of this area, for example, obtain the information that the oxide spacing area is in a range of grid units 2, 3, 6, 7, 10, 11. Furthermore, in the embodiment of present invention, each grid unit 1-12 consists of a plurality of sub-grid units with a specified dimension, ex. sub-grid 2a, which are arranged in a plurality of sub-grid columns and a plurality of sub-grid rows. Likewise, the grid unit 2a is preferably square, for example a square with a dimension of 2 μm*2 μm. In this way, each grid unit 1-12 will be provided with five sub-grid rows (horizontal), five sub-grid columns (vertical) and twenty five sub-grid units 2a, but not limited thereto. In the embodiment of present invention, the side length of sub-grid unit 2a is preferably greater than half width of the oxide spacing area to be tested.

After the layout data in the tested region is extracted, in step S2, critical factors like pattern density difference, minimum row/column pattern density and row/column pattern density difference of every grid unit are calculated based on the extracted layout pattern. More specifically, in the embodiment of present invention, the pattern density difference is equal to a pattern density of one of the sub-grid units with maximum pattern density in the grid unit minus a pattern density of one of the sub-grid units with minimum pattern density in the grid unit. Grid units 1-12 have their respective pattern density differences. For example, take grid unit 2 in FIG. 2 as an example, which is composed of twenty five sub-grid units, wherein the sub-grid unit 2a having minimum pattern density therein may be the one of the sub-grid units having blank oxide spacing area in bottom right border, and the sub-grid unit 2a having maximum pattern density therein may be one of other sub-grid units without blank oxide spacing area. Greater pattern density difference means there are more significant blank oxide spacing areas in a grid unit, which is a critical factor to determine if any oxide spacing area is located in certain grid unit region. Please note that in the preferred embodiment of present invention, the pattern in layout data is referred specifically to a dense area where copper interconnect lines gather, and a pattern density of a sub-grid unit is referred specifically to the pattern area of the sub-grid unit divided by the total area of the sub-grid unit.

In another aspect, in the embodiment of present invention, the minimum row/column pattern density is a pattern density of one of the sub-grid columns and the sub-grid rows with minimum row/column pattern density in a grid unit. Grid units 1-12 have their respective minimum row/column pattern density. More specifically, take grid unit 2 in FIG. 2 as an example in a similar way, with five sub-grid rows (horizontal) and five sub-grid columns (vertical) inside. The minimum row/column pattern density is the pattern density of one of the ten sub-grid rows/columns with minimum pattern density. It may be the 4th sub-grid row from top to bottom according to the pattern shown in FIG. 2, with significant large-scale blank oxide spacing area. Smaller minimum row/column pattern density means there are more significant blank oxide spacing area extending vertically or horizontally in a grid unit, which is a critical factor to determine if any oxide spacing area is located in certain grid unit region.

In another aspect, in the embodiment of present invention, the row/column pattern density difference is equal to a pattern density of one of the sub-grid rows with minimum pattern density in a grid unit minus a pattern density of one of the sub-grid columns with minimum pattern density in the grid unit. More specifically, take grid unit 2 in FIG. 2 as an example in a similar way, with five sub-grid rows (horizontal) and five sub-grid columns (vertical) inside. The row/column pattern density difference is equal to the pattern density of one of the five sub-grid rows having minimum pattern density (ex. 4th sub-grid row from top to bottom) minus the pattern density of one of the five sub-grid columns having minimum pattern density (ex. 3th sub-grid column from left to right). Greater row/column pattern density difference means there are more significant oxide spacing area extending vertically or horizontally in a grid unit, which is a critical factor to determine if any oxide spacing area is located in certain grid unit region. The row/column pattern density difference may also be used to determine the extending direction of an oxide spacing areas and the factors to be used in the calculation for the width of oxide spacing area later.

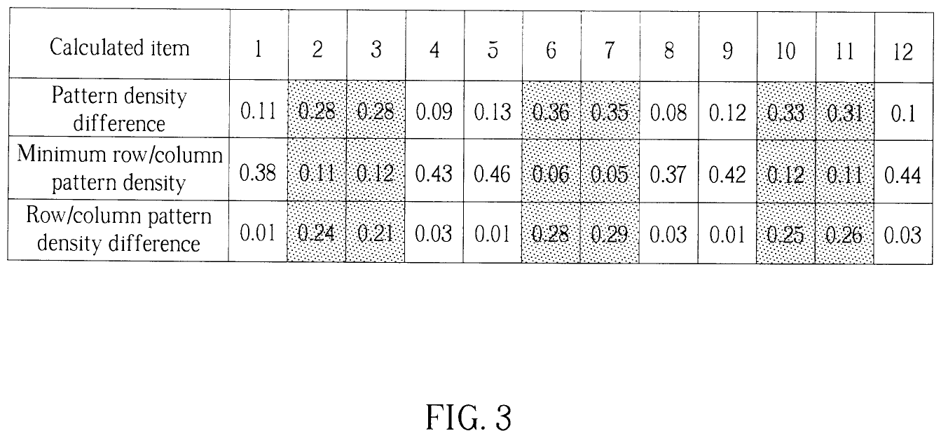

After the numerical values like the pattern density difference, minimum row/column pattern density, row/column pattern density difference of every grid unit are derived, next in step S3, comparing the pattern density difference, the minimum row/column pattern density and the row/column pattern density difference to corresponding predetermined values, so as to determine the grid location as where the blank oxide spacing area locates. More specifically, in the embodiment of present invention, if the pattern density difference of a grid unit is greater than a first predetermined value (ex. >0.2), the minimum row/column pattern density of the grid unit is less than a second predetermined value (ex. <0.13), and the row/column pattern density difference is greater than a third predetermined value (ex. >0.16), the grid unit is determined as where an oxide spacing area locates, but not limited thereto. The aforementioned predetermined values may be user-defined depending on product and requirement. FIG. 3 is a chart including data like pattern density difference, minimum row/column pattern density and row/column pattern density different of every grid unit 1-12 reached accordingly through the method of present invention, wherein the value columns meeting the decision method of present invention above in the chart is filled with shade. It can be seen in the chart that the values in grid units 2, 3, 6, 7, 10, 11 all meet the decision method of present invention, meaning there are oxide spacing areas in these grid units 2, 3, 6, 7, 10, 11, which matches the oxide spacing area shown in FIG. 2. This is exactly the method of deriving the location of oxide spacing area of the present invention.

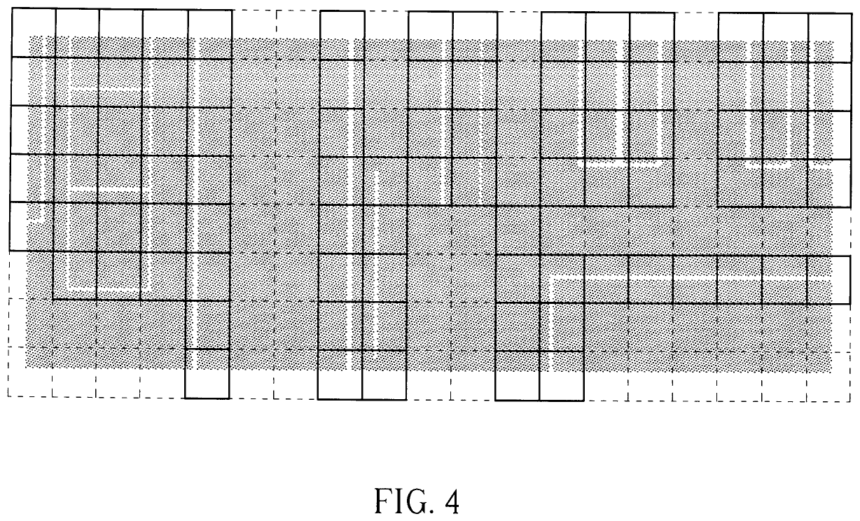

FIG. 4 is a schematic view of grid units having oxide spacing areas obtained according to the method of present invention. The locations of oxide spacing areas marked by the method of present invention can be seen in the figure, wherein these oxide spacing areas are usually in the shape of line or rectangle extending in horizontal direction or vertical direction, with large or small width. Please note that the width of oxide spacing area referred in the embodiment of present invention is the width in short axis direction, which is also the spacing between two pattern area isolated by the oxide spacing area. The larger the spacing, the more risk and extent the step height of the oxide spacing area lowered during CMP process.

Follow the aforementioned embodiment. After the location of blank oxide spacing area is detected, the width of detected oxide spacing area (width in short axis direction) is then calculated. In step S4, the orientation of pattern is determined first based on the row/column pattern density difference in the grid unit, and the side length of oxide spacing area is calculated based on the minimum sub-grid pattern density and pattern density of adjacent sub-grids therein. More specifically, in the embodiment of present invention, the sub-grid unit with minimum pattern density in a grid unit is found based on the extracted layout data, and this sub-grid unit is defined as a first sub-grid unit and its pattern density is defined as a minimum pattern density. Take the grid unit 2 in FIG. 2 as an example, wherein the sub-grid unit with minimum pattern density is in 4th column, 4th row or in 5th column, 4th row.

After the first sub-grid unit and the minimum pattern density in a grid unit are obtained, depending on the row/column pattern density difference of the grid unit obtained above, if the row/column pattern density difference of the grid unit is greater than 0, define one of the two sub-grid units adjoining horizontally to the first sub-grid unit having smaller pattern density as a second sub-grid unit and the pattern density of the second sub-grid unit is defined as a second minimum pattern density. If the row/column pattern density difference of the grid unit is less than 0, define one of the two sub-grid units adjoining vertically to the first sub-grid unit with smaller pattern density as a second sub-grid unit and define a pattern density of the second sub-grid unit as a second minimum pattern density.

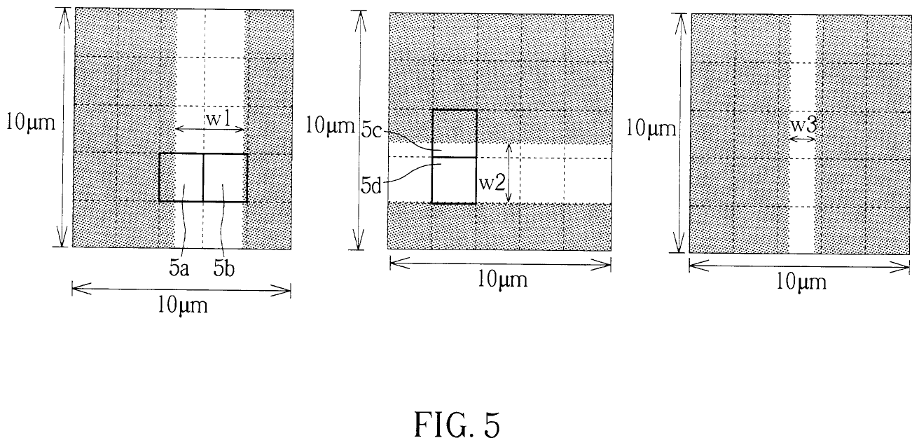

Take FIG. 5 as an example, which is a schematic view of several types of oxide spacing area in a grid unit in accordance with the embodiment of present invention, wherein the left pattern is exactly the pattern conform to the condition that the row/column pattern density difference in a grid unit is greater than 0. A row/column pattern density difference (i.e. minimum pattern density of sub-grid row minus minimum pattern density of sub-grid column) greater than 0 means its pattern density of sub-grid row would be greater than the one of sub-grid column on average, meaning there are more patterns in row direction, as well as reflects that the blank oxide spacing area in the grid unit should extends in vertical direction. Similarly, the middle pattern in FIG. 5 is conformed to the condition that the row/column pattern density difference in a grid unit is less than 0. A row/column pattern density difference (i.e. minimum pattern density of sub-grid row minus minimum pattern density of sub-grid column) less than 0 means its pattern density of sub-grid row would be less than the one of sub-grid column on average, meaning there are more patterns in column direction, as well as reflects that the blank oxide spacing area in the grid unit should extend in horizontal direction.

Refer still to FIG. 5. With regard to the type of left pattern, since its oxide spacing area extends in vertical direction, what the present invention wants to reach is the width w1 of the oxide spacing area in its short axis direction (i.e. horizontal direction). The width w1 may cover the range of two sub-grid units, with one sub-grid unit having greater pattern density (ex. sub-grid unit 5a) and the other sub-grid unit having less pattern density (ex. sub-grid unit 5b, which may be an entirely blank unit with zero pattern density). Accordingly, the sub-grid unit 5b and the sub-grid unit 5a adjoining horizontally thereto are respectively the first sub-grid and second sub-grid defined in the aforementioned step S4, which are provided respectively with minimum pattern density and second minimum pattern density. The horizontal width w1 is accordingly equal to (the side length of sub-grid unit)+(1−the second minimum pattern density)*(the side length of sub-grid unit).

In another aspect, refer still to FIG. 5. With regard to the type of middle pattern, since its oxide spacing area extends in horizontal direction, what the present invention wants to reach is the width w2 of the oxide spacing area in its short axis direction (i.e. vertical direction). The width w2 may cover the range of two sub-grid units, with one sub-grid unit having greater pattern density (ex. sub-grid unit 5c) and the other sub-grid unit having less pattern density (ex. sub-grid unit 5d, which may be an entirely blank unit with zero pattern density). Accordingly, the sub-grid unit 5d and the sub-grid unit 5c adjoining vertically thereto are respectively the first sub-grid and second sub-grid defined in the aforementioned step S4, which are provided respectively with minimum pattern density and second minimum pattern density. The vertical width w2 is accordingly equal to (the side length of sub-grid unit)+(1−the second minimum pattern density)*(the side length of sub-grid unit).

In addition, refer still to FIG. 5. There is another pattern type of oxide spacing area with a width less than the side length of one sub-grid unit, as the right pattern shown in FIG. 5. This pattern is conformed to the condition that the minimum pattern density is greater than 0. With regard to this pattern type, the width w3 of oxide spacing area is equal to (1−the minimum pattern density)*(the side length of sub-grid unit).

The present invention may evaluate if a region is potential high defect risk region according to the width of oxide spacing area derived from the embodiment above. For example, if the width of oxide spacing area is greater than a fourth predetermined value (ex. >0.5 μm), the oxide spacing area may be determined as a potential high defect risk region. Furthermore, the width of oxide spacing area obtained in the invention may also be used to predict the dishing extent and step height of lowered oxide spacing area.

According to the embodiments above, the method provided by the present invention may reach precise locations and sizes of oxide spacing areas between pattern areas, and use the data reached as model and parameter to predict the step height of grid. The advantage of the method of present invention lies in that the set values in the method, such as the dimension of grid unit, the dimension of sub-grid unit, the first to the fourth predetermined values, etc., may be customized and adjusted flexibly to be applied in various demands, products and condition analyses, and is suitable for the layout extraction and analysis of actual product in addition to testkey. Furthermore, its design and mechanism of grid unit and the sub-grid units may quickly and precisely calculate the location and size of oxide spacing area, saving excessive processing time and resource as well as solving the problem that all layout units should be defined and calculated directly in prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method to derive the location and size of oxide spacing area, comprising:
dividing a tested region in a GDS file into a grid composed of a plurality of grid units with a specified dimension, wherein each said grid unit consists of a plurality of sub-grid units with a specified dimension and arranged in a plurality of sub-grid columns and a plurality of sub-grid rows;
extracting layout data in said tested region;
calculating a pattern density difference of every said grid unit based on said layout data, wherein said pattern density difference is equal to a pattern density of one of said sub-grid units with maximum pattern density in said grid unit minus a pattern density of one of said sub-grid units with minimum pattern density in said grid unit;
calculating a minimum row/column pattern density of every said grid unit based on said layout data, wherein said minimum row/column pattern density is a pattern density of one of said sub-grid columns and said sub-grid rows with minimum pattern density in said grid unit;
calculating a row/column pattern density difference of every said grid unit based on said layout data, wherein said row/column pattern density difference is equal to a pattern density of one of said sub-grid rows with minimum pattern density in said grid unit minus a pattern density of one of said sub-grid columns with minimum pattern density in said grid unit; and
determining said grid unit as where an oxide spacing area locates at when said pattern density difference of said grid unit is greater than a first predetermined value, said minimum row/column pattern density of said grid unit is less than a second predetermined value and said row/column pattern density difference of said grid unit is greater than a third predetermined value.

2. The method to derive the location and size of oxide spacing area of claim 1, further comprising:
finding said sub-grid unit with minimum pattern density in said grid units, and defining said sub-grid unit with minimum pattern density as a first sub-grid unit, and defining a pattern density of said first sub-grid unit as a minimum pattern density;
defining one of two said sub-grid units adjoining horizontally to said first sub-grid unit having less pattern density as a second sub-grid unit and defining a pattern density of said second sub-grid unit as a second minimum pattern density when said row/column pattern density difference of said grid unit is greater than 0;
defining one of two said sub-grid units adjoining vertically to said first sub-grid unit having less pattern density as a second sub-grid unit and defining a pattern density of said second sub-grid unit as a second minimum pattern density when said row/column pattern density difference of said grid unit is less than 0;
determining a width of said oxide spacing area in said first sub-grid unit and said second sub-grid unit as being equal to (a side length of said sub-grid unit)+(1-said second minimum pattern density)*(a side length of said sub-grid unit) when said minimum pattern density is equal to 0; and
determining a width of said oxide spacing area in said first sub-grid unit and said second sub-grid unit as being equal to (1−said minimum pattern density)*(a side length of said sub-grid unit) when said minimum pattern density is greater than 0.

3. The method to derive the location and size of oxide spacing area of claim 2, further comprising predicting a potential defect risk region during chemical mechanical planarization process and a step height of said oxide spacing area based on said obtained location of said oxide spacing area and said width of said oxide spacing area.

4. The method to derive the location and size of oxide spacing area of claim 2, wherein if said width of said oxide spacing area is greater than a fourth predetermined value, determining said oxide spacing area as a potential defect risk region.

5. The method to derive the location and size of oxide spacing area of claim 1, wherein patterns in said layout data is patterns of dense areas of copper interconnect lines.

6. The method to derive the location and size of oxide spacing area of claim 5, wherein a pattern density of said sub-grid unit is equal to a pattern area in said sub-grid unit divided by a total area of said sub-grid unit.

7. The method to derive the location and size of oxide spacing area of claim 1, wherein said sub-grid unit is square, said oxide spacing area is rectangular, and said width of said oxide spacing area is a width of said oxide spacing area in short-axis direction.

8. The method to derive the location and size of oxide spacing area of claim 7, wherein said specified dimension of said grid unit is 10 μm*10 μm, said specified dimension of said sub-grid unit is 2 μm*2 μm, and each said grid unit is provided with five said sub-grid rows, five said sub-grid columns and twenty five said sub-grid units.
